(19) United States
(12) Patent Application Publication
(10) Pub. No.: US 2006/0267705 A1
(43) Pub. Date: Nov. 30, 2006

(54) Electrical conductor for signal transmission

(76) Inventor: Richard A. Schumacher, Dallas, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/137,523

(22) Filed: May 25, 2005

(51) Int. Cl. H01P 3/06

(52) U.S. Cl. 333/1; 333/243

(57) ABSTRACT

Embodiments include electrical conductors for signal transmission. One embodiment is a circuit board (CB). The CB has plural electrical transmission lines embedded within the CB. The transmission lines include an internal electrically conductive core surrounded by an electrically conductive plating material and an external dielectric surrounding the plating material. The core is formed of ferromagnetic material. The plating material is thinner than the core and is formed of non-ferromagnetic material.

### BACKGROUND

Computer systems and electronic devices use electrical signal channels or transmission lines to transmit signals. Some transmission lines are designed to transmit large amounts of data at high frequencies. Data transmission rates can exceed gigabytes per second over distances of one meter or more. Electrical transmission lines, however, incur frequency-dependent losses that reduce signal integrity and limit signal bandwidth.

Skin effect is one type of loss that effects signal propagation over transmission lines. When alternating current passes through a conductor, the current density near the surface of the conductor is greater than the current density near the core of the conductor. A high current density or “skin effect” occurs near the surface of the conductor. Skin effect causes the resistance of the conductor to increase as the frequency of the current increases.

Losses due to skin effect are particularly significant in high frequency data transmission. Skin effect creates inter-symbol interference (ISI) in high frequency data streams. In effect, data symbols are “smeared” in time and distorted. This distortion hampers reconstruction and interpretation of the received data.

Many techniques attempt to reduce skin effect and maintain signal integrity with minimal electrical losses. Some techniques, for example, endeavor to mitigate losses due to skin effect in circuit boards that utilize high frequency data transmission.

### BRIEF DESCRIPTION OF THE DRAWINGS

FIG. 1 is a cross-sectional view of an exemplary electrical conductor in accordance with the present invention.

FIG. 2 is a plan view of an exemplary circuit board (CB) in accordance with the present invention.

FIG. 3 is a partial cross-sectional view of an exemplary CB in accordance with the present invention.

FIG. 4 is a cross-sectional view of another exemplary electrical conductor in accordance with the present invention.

FIG. 5 is a cross-sectional view of another exemplary electrical conductor in accordance with the present invention.

FIG. 6 is a partial cross-sectional view of an exemplary electrical conductor within a CB in accordance with the present invention.

### DETAILED DESCRIPTION

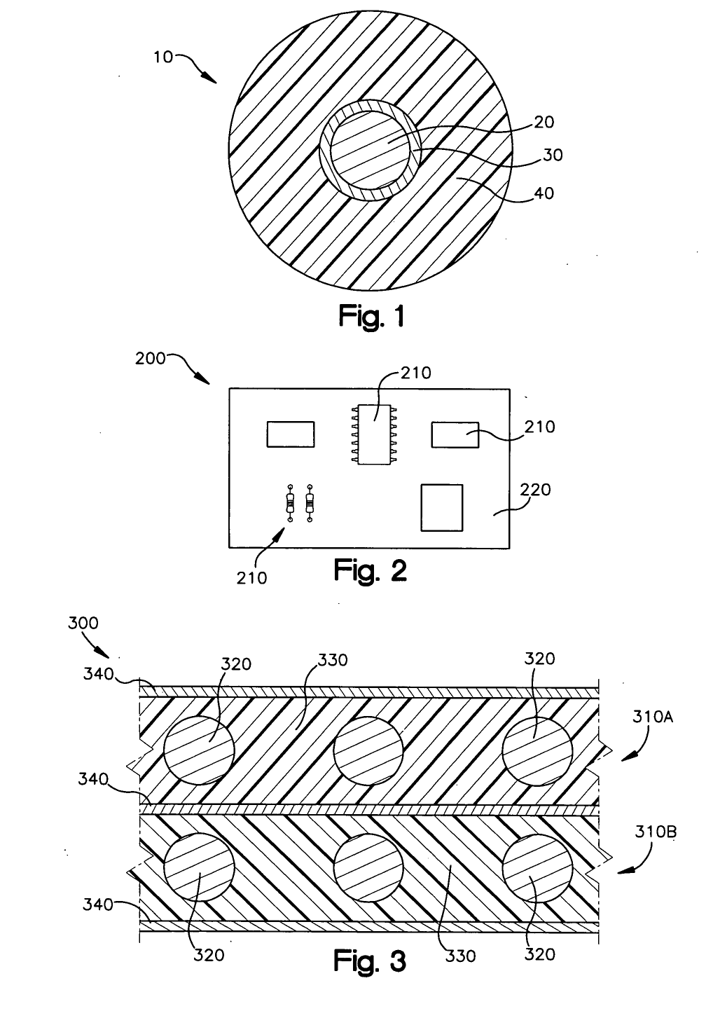

FIG. 1 illustrates an exemplary electrical conductor 10 for conducting electricity. As used herein, an “electrical conductor” is any material or object capable of transmitting an electric current. Further, the term “electrical conduction” means movement of charged particles of a material to produce an electric current. Electrical conductors can have various embodiments such as, but not limited to, wires, cables, transmission lines, etc.

In one exemplary embodiment, the electrical conductor 10 includes a conductive internal or core material 20, a conductive plating material 30 that surrounds the core material 20, and a dielectric 40 that surrounds both the plating material 30 and the core material 20.

The core material 20 is a material with relative magnetic permeability greater than unity and has a circular cross section that forms a core of the electrical conductor 10. Various materials can be used to provide both electrical conduction and relatively large magnetic permeability. Examples of such materials include, but are not limited to, nickel, certain nickel alloys, certain iron alloys, certain copper alloys, and other conductive magnetic materials and alloys.

The conductive plating material 30 has a circular cross section and forms a coating, shell, or plating around an outer surface of the core material 20. In one exemplary embodiment, the plating material 30 is less magnetic or is less magnetically permeable than the core material 20. For example, the core material 20 has a higher magnetic permeability than the plating material 30. In other embodiments, the plating material 30 is non-magnetic. As used herein, “permeability” or “magnetic permeability” is a degree or amount of magnetization of a material that linearly responds to a magnetic field, wherein permeability is measured in henrys per meter in the International System of Units (SI units).

Various materials can be used to provide electrical conduction for the plating material. Examples of such materials include, but are not limited to, gold, gold alloys, copper, certain copper alloys, non-magnetic conductive alloys, and other conductive low magnetic materials and alloys.

The dielectric 40 forms the outer surface or outer portion of the electrical conductor 10. The dielectric can be an electrical insulator, and various materials can be used for the dielectric material. As used herein, a “dielectric” is a substance that is highly resistant to the flow of electric current or that prevents the flow of electric current.

The electrical conductor 10 provides a self-equalizing conductor that compensates for skin effect losses during electrical conduction. Skin effect occurs because alternating (AC) current flows near the outer surface of an electrical conductor. In fact, a large fraction of AC current flows within one skin depth of the surface. Further, the current density rapidly decreases as the distance from the surface increases. Skin depth (S) is equal to:
S=(2ρ/ωμ)^{1/2}
where ρ is the resistivity of the conductor, ω is the angular frequency (2π×the frequency), and μ is the absolute magnetic permeability of the conductor.

As shown from the equation, the skin depth increases as the frequency of the transmitted signal increases. In other words, higher frequency current tends to flow in a thinner layer near the surface of the conductor and thus suffers increased resistive loss.

In one embodiment in accordance with the present invention, AC currents over a useful range of frequencies are constrained to flow in a layer of nearly constant thickness of the electrical conductor 10. As such, electrical conduction incurs skin effect loss that is nearly independent of frequency of the transmitted signal. Thus, currents at the lowest signaling frequency incur nearly the same skin effect resistive loss as do currents at the highest signaling frequency. This reduction of frequency-dependent loss reduces inter-symbol interference (ISI).

Skin effect loss is equalized over a useful range of signaling frequencies by using heterogeneous conductors in the electrical conductor 10. In one exemplary embodiment, for example, the core material 20 is made of material having high relative magnetic permeability. As one example, this material is a conductive ferromagnetic metal, such as nickel-iron alloy. The plating material 30 is made of a conductive non-ferromagnetic metal. The plating material 30 is metallurgically compatible with the core material 20 so the electrical conductor does not degrade over time. As one example, this material is copper or gold plating on a nickel alloy core. Examples of ferromagnetic materials include, but are not limited to, iron, nickel, cobalt, iron-nickel alloys, iron-cobalt alloys, iron-aluminum alloys, and iron-cobalt-nickel alloys, alloys/compounds containing these metals, and other crystalline materials that exhibit ferromagnetism.

As used herein, “ferromagnetic” materials or materials exhibiting “ferromagnetism” are substances that have an abnormally high magnetic permeability, a definite saturation point, and appreciable residual magnetism. Such substances cease being magnetic above a Curie point temperature and contain permanent atomic magnetic dipoles that are parallel oriented to one another in the absence of an external field.

The ferromagnetism and conductivity of the core material 20 are such that the skin depth for current of any given frequency is smaller than the skin depth of that same frequency in the plating material 30. As such, alternating current preferentially flows in the plating material 30 over the core material 20.

The minimum dimensions chosen for the core material 20 depend on numerous factors. For example, the dimensions depend on the conductivity of the chosen material, desired conductance at low frequencies, ease of fabrication of the completed conductor, suitability of the conductor for subsequent use in an assembly such as a CB, etc. In other embodiments, the core material 20 can include other materials that are chosen to modify the mechanical and other electrical properties of the conductor. For example, the direct current (DC) resistance of the conductor further decreases without increasing the overall diameter of the conductor 10 by using an inner core material (not shown) that is highly conductive material (example, copper) and compatible with the outer core material.

In one exemplary embodiment in accordance with the invention, the thickness of the plating material 30 is chosen so that, over a range of signaling frequencies of interest, the skin depths of those currents at those frequencies are smaller than the thickness of the plating material 30. Thus, the currents at those frequencies incur resistive loss that is mostly a function of the length of the conductor and mostly not a function of frequency. As such, the skin effect losses are equalized over the desired range of frequencies.

The thicknesses of the core and plating materials and the composition of the conductive materials can widely vary depending on the desired properties of the electrical conductor 10. Further, other factors (such as transmission line geometries) can vary and depend on the desired impedance according to principles and practices known to those skilled in the art.

The following example is provided as one illustration and is not provided to limit various other embodiments in accordance with the invention. Suppose, for example, the core material 20 is fabricated from nickel (or nickel alloy) with relative permeability of 120 and conductivity of 1.4×10⁷ mho per meter, and the plating material 30 is fabricated from copper (or copper alloy) with relative permeability of 1 and conductivity of 5.8×10⁷ mho per meter. Further, the core material 20 can have a thickness (i.e., diameter as shown in cross-section) of about 100 microns, and the plating material 30 can have a thickness (i.e., diameter as shown in cross-section) of about 1.2 microns. Thus, the plating material is substantially thinner (example, a magnitude of seven or greater) than the core material. The combination of these materials (nickel and copper) and diameters provides equalization of skin effect losses from about 300 MHz to about 3 GHz. In this exemplary embodiment, all frequencies in the exemplary range (about 300 MHz to about 3 GHz) incur a resistive skin effect loss of about 71 Ohms per meter length. The resistive losses in non-equalized uniform copper conductor of the same outer dimension vary from about 2.2 Ohms per meter length at 1 MHz to about 70 Ohms per meter at 3 GHz.

The electrical conductors in accordance with the present invention can be utilized in a wide variety of different computer systems and electrical devices. By way of example and not to limit other embodiments in accordance with the present invention, FIG. 2 shows a circuit board (CB) 200 having a plurality of heat generating components 210 disposed on a first surface 220. The CB 200 and/or heat generating components can utilize or be formed from electrical conductors in accordance with embodiments of the present invention. The electrical conductors, for example, provide electrical conduction between various heat generating components of the CB.

By way of example, CBs include printed wiring boards (PWBs), printed circuit boards (PCBs), multi-wire boards (MWBs), etc. CBs include a substrate or insulator on which various electronic components and/or heat generating components are placed and electrically connected with plural electrical conductors, electrically conductive wires, cables, transmission lines, etc. CBs include, but are not limited to, motherboards (example, boards with connectors for attaching components to a bus), daughterboards (example, boards that attach to another board), expansion boards (example, any board that connects to an expansion slot), controller boards (example, boards for controlling a peripheral device), backplanes (a CB having connectors into which other CBs can connect or be plugged), network interface cards (example, boards that enable a computer to connect to a network), power module circuit boards, voltage regulation module (VRM) circuit boards, and video adapters (example, boards that control a graphics monitor).

As used herein, a “heat generating device” or “heat generating component” includes any electronic component or device that generates heat during operation. For example, heat generating devices include, but are not limited to, resistors, capacitors, diodes, memories, electronic power circuits, integrated circuits (ICs) or chips, digital memory chips, application specific integrated circuits (ASICs), processors (such as a central processing unit (CPU) or digital signal processor (DSP)), discrete electronic devices (such as field effect transistors (FETs)), other types of transistors, or devices that require heat to be thermally dissipated from the device for the device to operate properly or within a specified temperature range.

FIG. 3 shows a partial cross-sectional view of an exemplary CB 300 in accordance with the present invention. The CB 300 includes plural vertically separate and different layers 310A, 310B. Each layer has plural electrical conductors 320 extending throughout the layer. The electrical conductors 320, for example, can be configured as the electrical conductor discussed in connection with FIG. 1 (electrical conductor 10) or any of the other embodiments.

In one exemplary embodiment, each layer 310A, 310B includes a dielectric 330 disposed between oppositely disposed, parallel, and spaced conductors 340. The conductors 340 can be, for example, fabricated from copper or other conductive material. The electrical conductors 320 are embedded within the dielectric material and between two conductors 340.

For illustration purposes, the CB 300 is shown with two layers. Embodiments in accordance with the present invention, though, are not limited to a specific number of layers and are equally applicable to a single layer or multiple layers.

In some embodiments in accordance with the present invention, the CB utilizing the electrical conductor 10 effectively mitigates skin effect losses. Thus, additional equalization components are not required. Lack of additional components saves surface area on the CB or chip and eliminates losses associated with poorly-controlled impedances of component escape etch and vias.

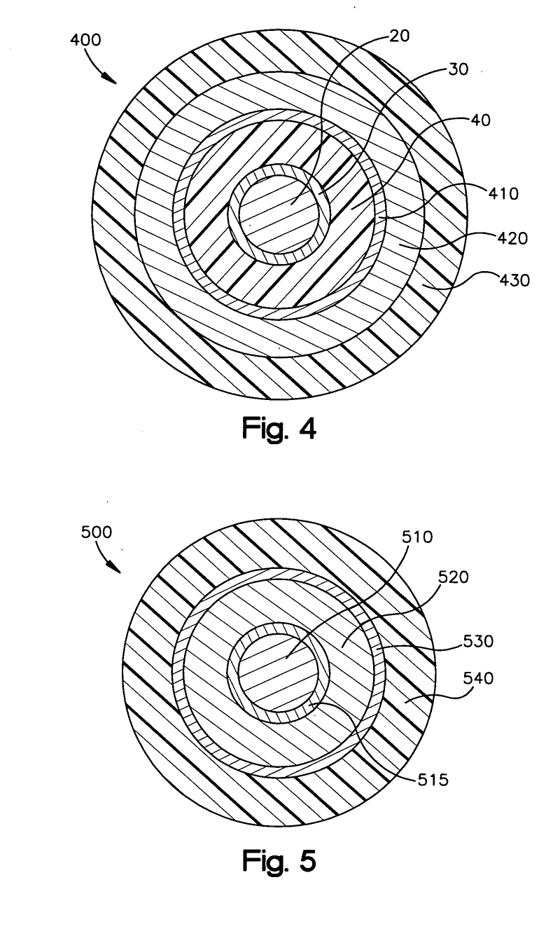

FIG. 4 shows a cross-sectional view of another exemplary electrical conductor 400 in accordance with the present invention. The electrical conductor has an inner portion similar to the electrical conductor 10 discussed in FIG. 1. Using like numerals to represent common features, the electrical conductor 400 includes an inner core material 20, a plating material 30, and a dielectric 40 that surrounds both the plating material 30 and the core material 20.

A second plating material 410 surrounds the dielectric 40. The plating material 410 includes embodiments as discussed in connection with the plating material 30 of FIG. 1. The plating materials 30 and 410 can be formed of the same or different materials. In one exemplary embodiment, for example, both plating materials are formed of copper or copper alloys.

A conductive material 420 surrounds the plating material 410. The conductive material 420 includes embodiments as discussed in connection with the core material 20 of FIG. 1. The core material 20 and the conductive material 420 can be formed of the same of different materials. In one exemplary embodiment, for example, both materials are formed from nickel or nickel alloys.

An insulator or insulating layer 430 surrounds the conductive material and provides an insulating outer shell or cover for the electrical conductor 400. In one embodiment, the insulating layer 430 is a nonconductive plastic or polymeric sheath.

In one exemplary embodiment, the electrical conductor 400 is provided as a coaxial cable. The cable is adapted to transmit high frequency or broadband signals, such as high frequency transmission lines (i.e., lines that transmit electromagnetic waves having wavelengths shorter than or comparable to the length of the actual line and including signals such as radio signals, microwave signals, optical signals, and other signals in digital circuits). The coaxial cable can be rigid or flexible depending on the application. The coaxial cable confines the signal (electromagnetic wave) to an area within the insulating layer 430 and, thus, forms a coaxial waveguide that propagates the signal inside the cable and between the conductors.

FIG. 5 shows a cross-sectional view of another exemplary electrical conductor 500 in accordance with the present invention. This embodiment includes a heterogeneous construction that provides reduced resistance at frequencies below the range of frequencies in which skin-effect equalization is desired. The electrical conductor has an inner conductive core material 510 with a conductive plating material 515. An outer conductive core material 520 surrounds the core material 510, and a plating material 530 surrounds the core material 520. An outer insulator 540 surrounds the plating material 530. The plating material 515 provides passivation and metallurgical compatibility between core materials 510 and 520 if these materials are incompatible in direct contact.

In one exemplary embodiment, the inner core 510 and the outer core 520 are formed from different conductive materials. For example, the inner core 510 is formed from copper or copper alloy, and the outer core 520 is formed from nickel or nickel alloy.

The plating material 530 includes embodiments as discussed in connection with the plating material 30 of FIG. 1. Further, the plating material 530 and the core 510 can be formed from the same or different materials. In one exemplary embodiment, for example, the plating material 530 and the inner core 510 are formed from the same conductive material (example, copper or copper alloy), and the outer core 520 is formed from a different conductive material (example, nickel or nickel alloy).

The insulator or insulating layer 540 surrounds the cores and plating material and provides an insulating outer shell or cover for the electrical conductor 500. In one embodiment, the insulating layer 540 is a nonconductive plastic or polymeric sheath.

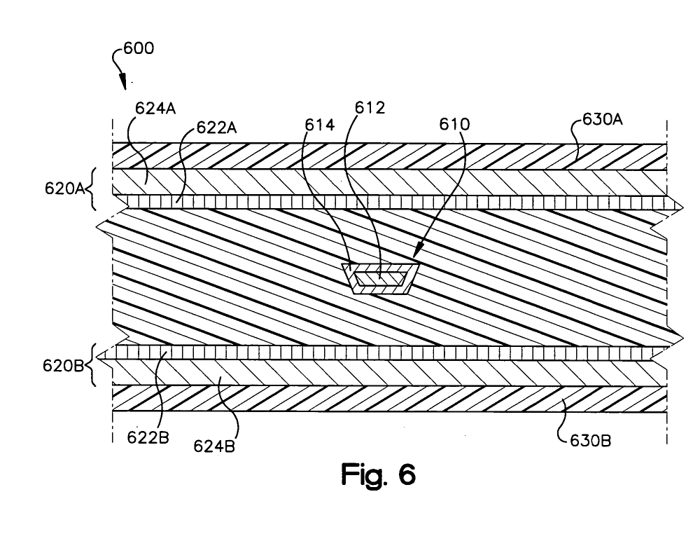

FIG. 6 shows a partial cross-sectional view of an exemplary CB 600 having a stripline construction transmission line. Signal conduction occurs within a signal conductor 610. In one exemplary embodiment, the signal conductor 610 is formed of an electrically conductive center or core 612 that is surrounded by an electrically conductive thin coating or layer 614. In one exemplary embodiment, the core 612 is nickel (Ni), and the layer 614 is copper (Cu). Thus, the signal conductor 610 is formed of two separate electrically conductive materials.

The signal conductor 610 is embedded or suspended within a dielectric material 618 that is disposed between two return conductors or electrically conductive layers 620A, 620B. Each conductive layer 620A, 620B is formed of two different electrically conductive metals. The conductive layer 620A is formed of a first thin layer 622A and a second thicker layer 624A. The conductive layer 620B is formed of a first thin layer 622B and a second thicker layer 624B. In one exemplary embodiment, the layers 622A, 622B are formed of copper, and the layers 624A, 624B are formed of nickel. Thus, the thinner layers 622A, 622B face the signal conductor 610. Two dielectric layers 630A, 630B are positioned adjacent the conductive layers 620A, 620B.

FIG. 6 illustrates an example of a stripline within a CB. The two dielectrics 630A, 630B are provided at outermost surfaces (i.e., a top and bottom of the CB). In other exemplary embodiments, one or both of these dielectrics 630A, 630B can be replaced with another thin electrically conductive layer (such as copper) as part of a repetition of the stripline structure. As yet another example, one or both of these dielectrics 630A, 630B can be replaced with a thicker electrically conductive layer (such as copper) as part of a power distribution layer. As still yet another example, one or both of these dielectrics 630A, 630B can be replaced with a plating of gold or other passivation material to serve as the outer surface of the CB 600.

While the invention has been disclosed with respect to a limited number of embodiments, those skilled in the art will appreciate, upon reading this disclosure, numerous modifications and variations. It is intended that the appended claims cover such modifications and variations and fall within the true spirit and scope of the invention.

What is claimed is:

1) A circuit board, comprising:
plural electrical transmission lines embedded within the circuit board (CB), wherein the transmission lines include an internal electrically conductive core surrounded by an electrically conductive plating material and an external dielectric surrounding the plating material, the core being formed of ferromagnetic material and the plating material being thinner than the core and formed of non-ferromagnetic material.

2) The circuit board of claim 1, wherein the core includes nickel and the plating material includes one of gold and copper.

3) The circuit board of claim 1, wherein the transmission lines have a circular cross-section with the plating material disposed around an outer surface of the core and the dielectric disposed around an outer surface of the plating material.

4) The circuit board of claim 1, wherein the core has a first skin depth for alternating current (AC) of a given frequency, and the plating material has a second skin depth, larger than the first skin depth, for the AC of the given frequency.

5) The circuit board of claim 1, wherein electrical losses due to skin effect are equalized over a range of different frequencies for alternating currents conducting through the transmission lines.

6) A circuit board, comprising:
an electrical transmission line embedded in a dielectric of the circuit board (CB) and including a metallic core and a metallic plating material disposed on an outer surface of the core, wherein the plating material is a different material than the core and has a thickness such that, over a range of different signaling frequencies through the transmission line, skin depths at these different frequencies are greater than the thickness of the plating material.

7) The circuit board of claim 6, wherein electrical losses due to skin effect are equalized over the range of different signaling frequencies.

8) The circuit board of claim 6, wherein the core is formed of nickel and the plating material is formed of copper.

9) The circuit board of claim 6, wherein alternating currents over the range of different signaling frequencies that conduct through the transmission line have a constant current density throughout a same thickness.

10) The circuit board of claim 6, wherein alternating currents at first and second frequencies incur a same electrical loss from skin effect, the first frequency being larger than the second frequency.

11) The circuit board of claim 6, wherein the core has a higher magnetic permeability than a magnetic permeability of the plating material.

12) The circuit board of claim 6, wherein the core is formed of a ferromagnetic metal, and the plating material is formed of a non-ferromagnetic metal.

13) A method, comprising:
embedding plural electrical transmission lines in a circuit board (CB), the transmission lines formed from a ferromagnetic conductive core and a metallic plating material disposed around the core; and
selecting material properties of the core and the plating material such that current transmitted through the transmission lines preferentially flows in the plating material.

14) The method of claim 13 further comprising:
transmitting a signal through the transmission lines to generate a first skin depth in the core and a second skin depth in the plating material, the first skin depth being smaller than the second skin depth.

15) The method of claim 13, wherein the current has a constant current density through a thickness of the transmission lines over a range of different frequencies.

16) The method of claim 13, further comprising selecting the material properties of the core and the plating material to equalize electrical loss from skin effect.

17) The method of claim 13, wherein currents at a first frequency and currents at a second frequency incur a same electrical skin effect loss when transmitted through the transmission lines.

18) A coaxial cable, comprising:
an electrically conductive core;
a first conductive metallic plating surrounding the core, the first plating having a thickness less than a thickness of the core;
a dielectric surrounding the plating;
a second conductive metallic plating surrounding the core, the second plating having a thickness less than the thickness of the core;
a conductive metallic layer surrounding the second plating; and
an insulating layer surrounding the conductive metallic layer and enclosing the coaxial cable.

19) The coaxial cable of claim 18, wherein the core is formed of ferromagnetic material, and the first and second platings are formed of non-ferromagnetic material.

20) The coaxial cable of claim 18, wherein the first and second platings are formed of copper, and the core and the conductive metallic layer are formed of nickel.
